(19) United States
(12) Patent Application Publication
(10) Pub. No.: US 2017/0139492 A1
(43) Pub. Date: May 18, 2017

(54) STYLUS

(71) Applicant: eGalax_eMPIA Technology Inc., Taipei City (TW)

(72) Inventors: Chin-Fu CHANG, Taipei City (TW); Shang-Tai YEH, Taipei City (TW)

(21) Appl. No.: 15/010,651

(22) Filed: Jan. 29, 2016

(30) Foreign Application Priority Data
Nov. 12, 2015 (TW) 104137354

(51) Int. Cl. G06F 3/0354

(52) U.S. Cl. CPC G06F 3/03545

(57) ABSTRACT

A stylus includes electrically conductive pen body including accommodation chamber and connection portion at end of accommodation chamber, core member mounted in accommodation chamber, and pen cap made of electrically non-conductive material and including conical base, mounting portion located at rear side of conical base and fastenable to connection portion, insertion hole for passing of core member, grooves located at periphery of conical base and conducting layer coated on surface of conical base, surface of each groove and surface of mounting portion for conduction with electrically conductive pen body. After long uses, part of conducting layer in each groove can be maintained intact and in integrity with part of conducting layer at mounting portion. Conducting layer can be positively and electrically conducted with electrically conductive material of pen body to provide effective shielding effect for protection of internal electronic components of stylus against external EMI and static electricity.

### BACKGROUND OF THE INVENTION

### 1. Field of the Invention

The present invention relates to a touch-sensing input device and more particularly, to a stylus of which the pen body is made of an electrically conductive material, the pen cap is made of an electrically non-conductive material and having at least one groove located at the periphery and a conducting layer coated on the outer surface thereof. After long uses in mounting and dismounting between the pen body and the pen cap, the conducting layer in the at least one groove is maintained intact for grounding to maintain the electromagnetic shielding effect.

### 2. Description of the Related Art

With fast development of modern technology, various advanced electronic products such as smart phone, touchscreen computers and TVs that have the characteristic of ease of use have been created and appeared on the market. Instead of the use of a keyboard or keypad in a computer or mobile phone for data input, a smart phone, tablet computer, touch screen computer or touch screen TV allows a user to operate it by touching or approaching a software icon on the surface of its touch screen directly with the finger or by means of a stylus without inputting complicated text instructions.

Further, when operating a touch screen electronic device, people usually will click, or touch and drag on the touch screen directly with the finger. Finger operation is intuitive and convenient, however, it is not suitable for all occasions. When a user touches and drags on the touch screen of a touch screen electronic device with the finger in writing text, the friction pressure between the finger and the touch screen cannot be well controlled, therefore, finger touch is not suitable for fast input or large amount of data input. Further, when clicking an application software or a virtual button, because of the problem of finger thickness, inadvertent clicking can occur, or the user can click two or more virtual buttons at a time. After consideration of the general habits of people, stylus is created. A stylus is a small pen-shaped instrument that is used to input commands to a touch screen electronic device. A user can place a stylus on the surface of the screen to draw or make selections by tapping the stylus on the screen.

There are two types of styluses available on the market, namely passive type stylus and active type stylus. A passive stylus is a pen that acts just like a finger when touching a device screen. There is no communication between a passive stylus and a device. Touch of a passive type stylus to the touch screen of an electronic device is sensed by the touch screen of the electronic device. On the other hand, an active type stylus is able to communicate with the touch screen of the electronic device. With this communication, some commands are able to be sent to the electronic device through the stylus.

Referring to FIGS. 6 and 7, a conventional active stylus is shown comprising a pen body A made of an electrically conductive material, a pen cap B made of an electrically non-conductive material and a core member C. The pen body A comprises an accommodation chamber A1 therein, a connection portion A2 located at a front end of the accommodation chamber A1 and an abutment edge A3 located at a front end of the connection portion A2. The pen cap B comprises a conical base B1, a mounting portion B2 backwardly extended from a rear side of the conical base B1 at the center, a contact surface portion B11 located at the rear side of the conical base B1 around the mounting portion B2, an insertion hole B3 axially cut through the conical base B1 and the mounting portion B2, and a conducting layer B4 coated on the outer surface thereof. After mounting of the core member C in the accommodation chamber A1 of the pen body A, attach the insertion hole B3 of the pen cap B onto the core member C and then fasten the mounting portion B2 to the connection portion A2 of the pen body A. At this time, the conducting layer B4 of the pen cap B is kept in conduction with the electrically conductive pen body A to provide an electromagnetic shielding effect for protection against external EMI and static electricity upon touching between the active stylus and the touchscreen, ensuring accurate performance and preventing internal component damage.

However, after long uses in mounting and dismounting between the pen body A and the pen cap B, the part of the conducting layer B4 of the pen cap B at the contact surface portion B11 can be worn off by the abutment edge A3 of the pen body A. At this time, conduction between the conducting layer B4 of the pen cap B and the electrically conductive material of the pen body A fails, loosening the EMI shielding function and leading to signal transmission instability, sensing error and performance failure.

Therefore, it is desirable to provide a stylus that eliminates the foresaid problems.

### SUMMARY OF THE INVENTION

The present invention has been accomplished under the circumstances in view. It is therefore the main object of the present invention to provide an stylus, which provides an effective shielding effect for protection of the internal electronic components of the stylus against external EMI and static electricity.

To achieve this and other objects of the present invention, a stylus comprises a pen body, a pen cap, and a core member. The pen body is made of an electrically conductive material, comprising an accommodation chamber and a connection portion at one end of the accommodation chamber. The core member is mounted in the accommodation chamber of the pen body, having one end thereof terminating in a pen tip. The pen cap is made of an electrically non-conductive material, comprising a conical base, a mounting portion located at a rear side of the conical base and fastenable to the connection portion of the pen body, an insertion hole axially cut through the conical base and the mounting portion for the passing of the core member, one or multiple grooves located at the periphery of the conical base and a conducting layer coated on the surface of the conical base, the surface of each groove and the surface of the mounting portion for conduction with the electrically conductive pen body. After long uses, even if the part of the conducting layer at the contact surface portion at the rear side of the conical base is worn off by the abutment edge at the front end of the connection portion of the pen body, the part of the conducting layer in each groove can be maintained intact and in integrity with the part of the conducting layer at the mounting portion, and thus, the conducting layer can be positively and electrically conducted with the electrically conductive material of the pen body to provide an effective shielding effect for protection of the internal electronic components of the stylus against external EMI and static electricity.

Preferably, the pen body is made of metal, and the pen cap is made of a flexible plastic material. When fastening the pen cap to the pen body, the material characteristics of the hard metal of the pen body and the flexible plastic material of the pen cap enable the pen body and the pen cap to be tightly secured together, enhancing conduction between the metal of the pen body and the conducting layer of the pen cap and avoiding EMI protection failure.

Preferably, the pen cap has multiple grooves equiangularly spaced around the periphery of the conical base, ensuring positive conduction between the conducting layer of the pen cap and the electrically conductive material of the pen body to provide a high level of EMI protection.

### BRIEF DESCRIPTION OF THE DRAWINGS

FIG. 1 is an oblique top elevational view of a stylus in accordance with a first embodiment of the present invention.

FIG. 2 is an exploded view of the stylus in accordance with the first embodiment of the present invention.

FIG. 3 is a sectional side view, in an enlarged scale, of a part of the stylus in accordance with the first embodiment of the present invention.

FIG. 4 is an oblique top elevational view of a stylus in accordance with a second embodiment of the present invention.

FIG. 5 is a sectional side view, in an enlarged scale, of a part of the stylus in accordance with the second embodiment of the present invention.

FIG. 6 is an oblique top elevational view of a stylus according to the prior art.

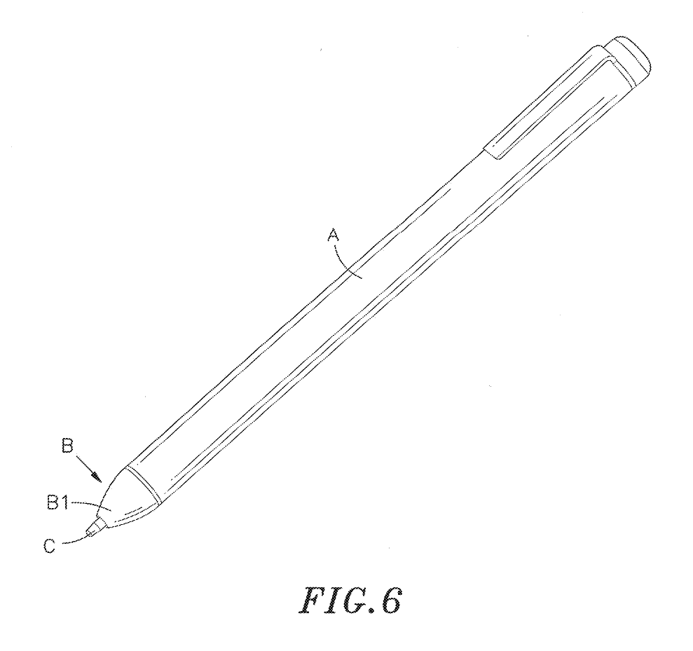

FIG. 7 is a sectional side view, in an enlarged scale, of a part of the stylus according to the prior art.

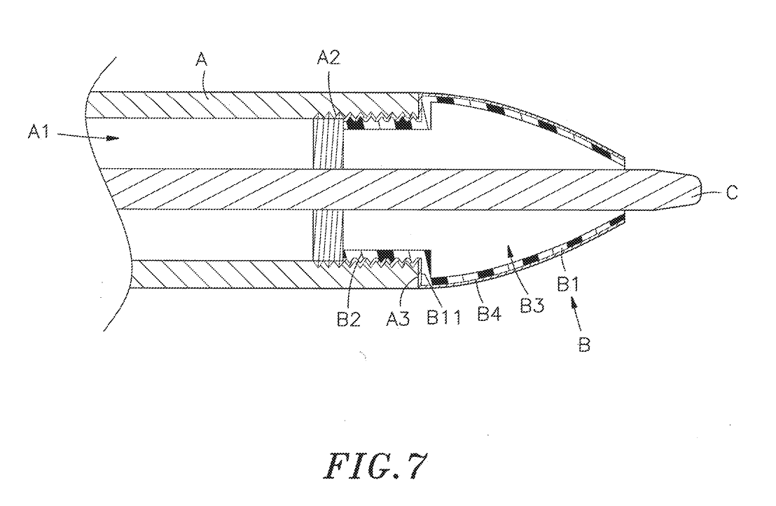

### DETAILED DESCRIPTION OF THE PREFERRED EMBODIMENT

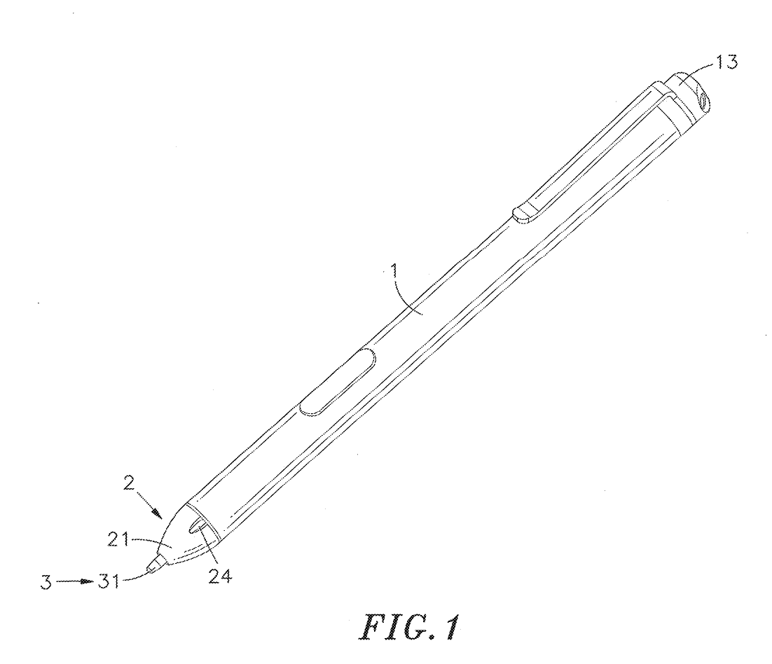

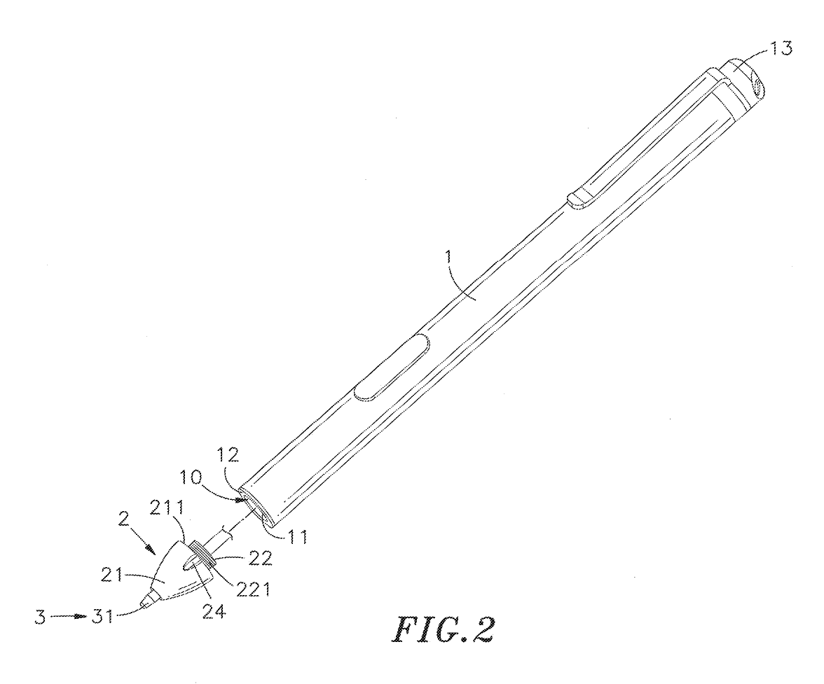

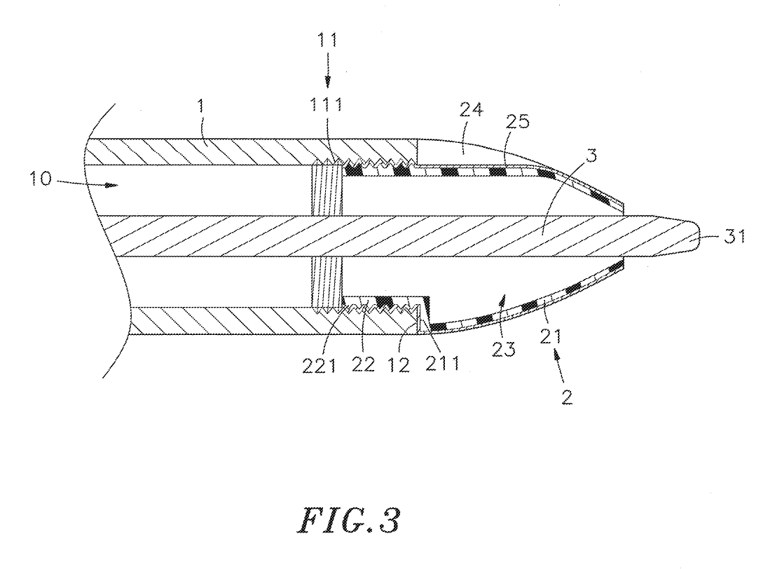

Referring to FIGS. 1-3, a stylus in accordance with a first embodiment of the present invention is shown. As illustrated, the stylus comprises a pen body 1, a pen cap 2 and a core member 3.

The pen body 1 is tubular member made of an electrically conductive material (such as metal), comprising therein an accommodation chamber 10, a connection portion 11 located at one end of the accommodation chamber 10, an inner thread 111 located in the connection portion 11, an abutment edge 12 located at one end, namely, the front end of the pen body 1 and abutted to the connection portion 11, and an outer cap 13 located at an opposite end, namely, the rear end of the pen body 1.

The pen cap 2 is made of an electrically non-conductive material (such as plastics), comprising a conical base 21, a mounting portion 22 backwardly extended from a rear side of the conical base 21, a contact surface portion 211 located at the rear side of the conical base 21 around the mounting portion 22, an outer thread 221 extending around the periphery of the mounting portion 22, an insertion hole 23 axially cut through the conical base 21 and the mounting portion 22 at the center, at least one groove 24 located at the periphery of the conical base 21 and extended to the contact surface portion 211 and a conducting layer 25 coated on the surface of the conical base 21, the surface of the mounting portion 22 and the surface of each groove 24.

The core member 3 has one end thereof terminating in a pen tip 31.

When assembling the stylus, insert the core member 3 through the front end of the pen body 1 remote from the outer cap 13 into the accommodation chamber 10. After insertion of the core member 3 into the end in the accommodation chamber 10, the pen tip 31 of the core member 3 is exposed to the outside of the front end of the pen body 1. Thereafter, attach the pen cap 2 onto the pen tip 31 of the core member 3 to couple the insertion hole 23 to the pen tip 31 of the core member 3 and to force the mounting portion 22 of the pen cap 2 into alignment a rid contact with the connection portion 11 of the pen body 1, and then rotate the pen cap 2 to thread the outer thread 221 around the mounting portion 22 into engagement with the inner thread 111 in the connection portion 11 to the extent where the contact surface portion 211 of the pen cap 2 is abutted against the abutment edge 12 of the pen body 1 and the pen tip 31 of the core member 3 is exposed to the outside of the pen cap 2. At this time, the assembly process is done.

As stated above, the pen cap 2 comprises at least one groove 24 located at the periphery of the conical base 21. After long uses in mounting and dismounting between the pen body 1 and the pen cap 2, the part of the conducting layer 25 of the pen cap 2 at the contact surface portion 211 can be worn off by the abutment edge 12 of the pen body 1, however, because the abutment edge 12 of the pen body 1 will never touch the part of the conducting layer 25 of the pen cap 2 in the at least one groove 24, the part of the conducting layer 25 of the pen cap 2 in the at least one groove 24 can be maintained intact for grounding to maintain the electromagnetic shielding effect, and thus, the part of the conducting layer 25 of the pen cap 2 in the at least one groove 24 can be constantly kept in conduction with the part of the conducting layer 25 of the pen cap 2 at the mounting portion 22. After connection between the pen body 1 and the pen cap 2, the conducting layer 25 at the mounting portion 22 is electrically conducted with the electrically conductive material of the pen body 1 to provide an effective shielding effect for protection of the internal electronic components (not shown) against external EMI and static electricity, preventing signal transmission interruptions. When using this design of stylus with a sensing panel (not shown), error detection can be avoided, assuring a high level of signal transmission stability and system application reliability and durability.

Further, if metal is selected for making the pen body 1, the plastic material for the pen cap 2 can be flexible. Thus, when fastening the pen cap 2 to the pen body 1, the material characteristics of the hard metal of the pen body 1 and the flexible plastic material of the pen cap 2 enable the pen body 1 and the pen cap 2 to be tightly secured together, enhancing conduction between the metal of the pen body 1 and the conducting layer 25 of the pen cap 2 and avoiding EMI protection failure.

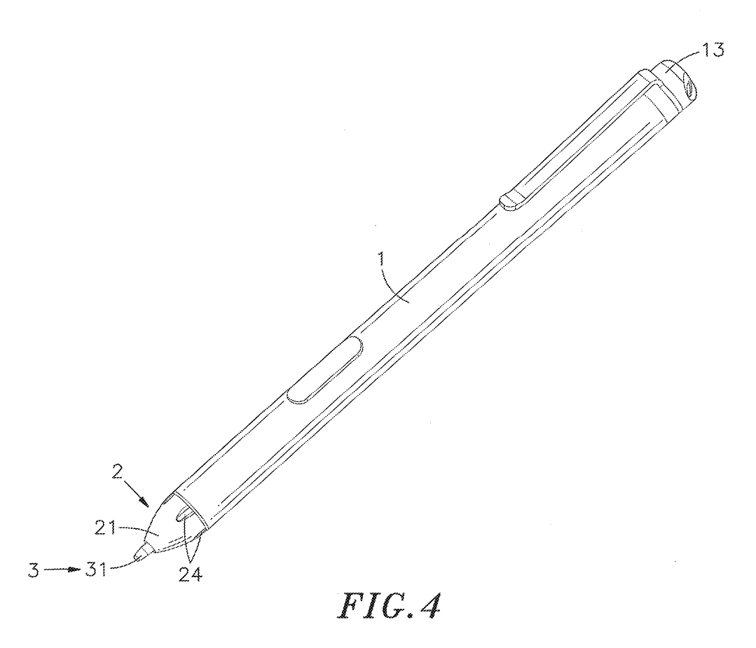

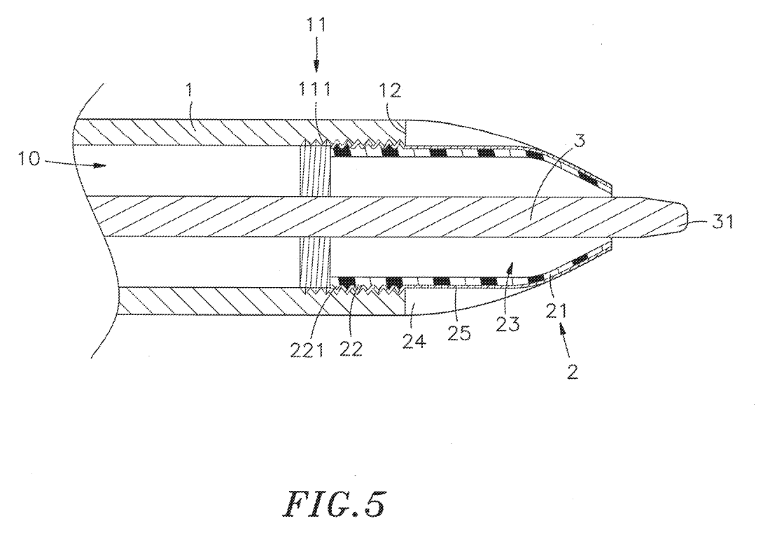

Referring to FIGS. 4 and 5, the pen cap 2 can be designed to provide a plurality of grooves 24 that are equiangularly spaced around the periphery of the conical base 21. After long uses of the stylus, the part of the conducting layer 25 of the pen cap 2 at the mounting portion 22 can be maintained in connection with the part of the conducting layer 25 of the pen cap 2 in the grooves 24 for grounding, assuring a high level of EMI and static electricity shielding performance.

In general, the invention provides a stylus, which comprises an electrically conductive pen body 1, which comprises an accommodation chamber 10 and a connection portion 11 at a front end of the accommodation chamber 10, a pen cap 2, which is made of an electrically non-conductive material and comprises a conical base 21, a mounting portion 22 extended from a rear side of the conical base 21 for connection to the connection portion 11 of the pen body 1, an insertion hole 23 axially cut through the conical base 21 and the mounting portion 22 and a conducting layer 25 coated on the outer surface of the conical base 21 and the mounting portion 22, and a core member 3 positioned in the insertion hole 23 of the pen cap 2 and the accommodation chamber 10 of the pen body 1, wherein the pen cap 2 comprises at least one groove 24 located at the periphery thereof; the conducting layer 25 extends over an inner surface of each groove 24 to the mounting portion 22.

After long uses in mounting and dismounting between the pen body 1 and the pen cap 2, the part of the conducting layer 25 of the pen cap 2 in the at least one groove 24 can be maintained intact and in integrity with the part of the conducting layer 25 at the mounting portion 22, and thus, after connection between the pen body 1 and the pen cap 2, the conducting layer 25 of the pen cap 2 is positively and electrically conducted with the electrically conductive material of the pen body 1 to provide an effective shielding effect for protection of the internal electronic components of the stylus against external EMI and static electricity, preventing signal transmission interruptions.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A stylus, comprising:
a pen body being a tubular member made of an electrically conductive material, said pen body comprising therein an accommodation chamber and a connection portion located at one end of said accommodation chamber;
a pen cap made of an electrically non-conductive material, said pen body comprising a conical base, a mounting portion located at a rear side of said conical base for connection to said connection portion of said pen body, an insertion hole axially cut through said conical base and said mounting portion, at least one groove located at the periphery of said conical base, and a conducting layer coated on the surface of said conical base, the surface of said mounting portion and the surface of each said groove to achieve conduction with said electrically conductive material of said pen body after connection between said mounting portion of said pen cap and said connection portion of said pen body; and
a core member positioned in said accommodation chamber of said pen body and said insertion hole of said pen cap.

2. The stylus as claimed in claim 1, wherein said pen body further comprises an inner thread located in said connection portion; said pen cap further comprises an outer thread extended around the periphery of said mounting portion for threading into said inner thread of said pen body.

3. The stylus as claimed in claim 1, wherein said pen body further comprises an abutment edge located at an outer end of said connection portion; said pen cap further comprises a contact surface portion located at the rear side of said conical base around said mounting portion for abutment against said abutment edge of said pen body.

4. The stylus as claimed in claim 3, wherein said pen cap comprises a plurality of said grooves equiangularly spaced around the periphery of said conical base.

5. The stylus as claimed in claim 1, wherein said pen body further comprises an outer cap capped on a rear end thereof remote from said connection portion.

6. The stylus as claimed in claim 1, wherein said core member comprises a pen tip located at a front end thereof and exposed to the outside of said pen cap.
